(19) United States
(12) Patent Application Publication
(10) Pub. No.: US 2015/0248166 A1
(43) Pub. Date: Sep. 3, 2015

(54) SYSTEM FOR SPONTANEOUS RECOGNITION OF CONTINUOUS GESTURE INPUT

(71) Applicant: Shangkar Meitei Mayanglambam, Santa Clara, CA (US)

(72) Inventor: Shangkar Meitei Mayanglambam, Santa Clara, CA (US)

(21) Appl. No.: 14/164,206

(22) Filed: Jan. 26, 2014

(51) Int. Cl. G06F 3/01; G06F 3/0338; G06F 3/0354; G06F 3/041

(52) U.S. Cl. CPC G06F 3/017; G06F 3/041; G06F 3/0338; G06F 3/03545

(57) ABSTRACT

This invention comprises of a special class of directional gesture patterns, a computational system for spontaneous recognition of continuous gesture pattern inputs and a methodology to map the gesture patterns to characters, symbols and control functions. The gesture path in two dimensional coordinate systems can be captured by any touch surface device or camera based position tracking technologies like WII remote, Microsoft XBOX or gyroscopic devices to track motion. The special class of directional gesture patterns called mayek may be composed with a sequence of gesture segments. The directions of the adjacent gesture segments of the mayek patterns may be assigned alternately from two different direction subsets. For example, one of the direction subset may be {north, south, east, west} and the other direction subset may be {north-east, north-west, south-east, south-west}. The gesture recognition system may recognize the patterns entered non-stop in running writing style. ASCII characters may be mapped to gesture patterns with maximum two gesture segments.

### CROSS-REFERENCE TO RELATED APPLICATIONS

This application claims the benefit of provisional patent application Ser. No. 61/757,101, filed 2013 Jan. 26 by the present inventor.

### BACKGROUND

The following is a tabulation of some prior art that presently appears relevant:

### U.S. Patent Publications

| Publication | Kind | | |
|---|---|---|---|
| Number | Code | Publication Date | Applicant |
| U.S. Pat. No. | A | Jan. 21, 1997 | David Goldberg |
| 5,596,656 | | | |
| U.S. Pat. No. | B1 | Dec. 10, 2002 | Jeffrey C. Hawkins, Joseph |
| 6,493,464 | | | Kahn Sipher, Marinetti II Ron |
| U.S. Pat. No. | B2 | Jun. 1, 2010 | Jacob O. Wobbrock, Brad A. |
| 7,729,542 | | | Myers |

This invention relates to systems for entering gesture input in data processing devices like wristwatches, media players, phones, tablets, laptops, desktops, game consoles, GPS devices, remote controls and any other input devices. In particular, this invention relates to recognizing a special class of patterns entered with gesture and translating it to the relevant input text. The gesture input apparatus may be powered by technologies like touch screen, joysticks, accelerometer, and any other position tracking systems like WII remote.

Traditional full size keyboards with suitable dimension to accommodate both hands have been the most convenient text input device for computerized systems for a very long time. In fact, the hardware keyboards offer two crucial capabilities for text input 1) enables very fast typing by using multiple fingers on both hands 2) enables typing without looking at the keyboard. Of course, it takes time for a new user to get used to the keyboard layout to enjoy these capabilities. Text input speed is limited by the time delay of inputting a subsequent character after the previous character was inputted. While typing with multiple fingers the input efficiency is significantly improved because of two reasons 1) since the keys are distributed to multiple fingers, the movement path length for each finger is reduced 2) while a character is being typed by one finger, another finger on the different hand can start moving towards the subsequent character simultaneously. Further, many individuals who have thoroughly remembered the keyboard layout can type without looking at the keyboard. This allows the user to focus on what is being written rather than stressfully switching focus between keyboard and the input text displayed. However, it's not possible for many individuals to completely avoid looking at the keyboard while typing.

On the other hand, there are small portable devices equipped with tiny keyboards either in the form of hardware or virtual interfaces. It's cumbersome to input long texts with multi-tap keypad based devices like older generation phones. The touch screen based smart-phones are far better by providing virtual keyboard layout similar to traditional keyboards. Unfortunately, the virtual keyboard is far from being convenient interface due to the limited size of the keypad area. For such keypads, it's not possible to use multiple fingers effectively and also user needs to constantly look at the keypad while typing. This can be extremely stressful experience to input longer texts. Further, there are bigger virtual keypads for tablets. But the increased size of the virtual keyboard is not very effective in improving the write efficiency and convenience. This is because virtual keyboards are on the same plane as the display itself which makes it inconvenient to 1) use two hands for typing 2) position hand while the display is positioned in front. In some of the game consoles, text input by moving cursor controlled by gesture or joystick is also very slow.

For the environments where usage of multiple fingers for inputting text is not convenient, gesture or drawing or writing based text input process can be more suitable provided the writing system is accurate, easy and enables fast input. Unfortunately, traditional alphabets used for writing have complex shapes making it difficult to be written by blunt finger tips or stylus and recognition system accuracy is very limited for small size writing or drawing input. Recognizing drawings rendered by blunt stylus tips and finger tips can be effective only if the size of the drawing is bigger. This makes drawing or writing the alphabet symbols inconvenient and slow. In order to overcome these challenges, researchers and inventors in the past have tried to come up with customized alphabet sets which are more suitable for more effective input and recognition. Unistroke symbols in U.S. Pat. No. 5,596,656 are one of the early efforts for enabling handwriting input. As the name suggests, each of the unistroke symbols are drawn with separate single strokes making it slower to input long text and also the structure of these symbols are not optimized for fast and convenient input. Further, these symbols are mapped to Latin alphabet symbols without considering any structural similarity and ease of learning. This makes it more difficult to remember the symbols which can negatively impact adoption of this input system by new users.

Graffiti is also another form of unistroke alphabet from Palm Inc which resembles more to traditional Latin alphabet. This helps to make it easier to remember the Graffiti symbols but it compromises the write speed efficiency which is more crucial over long period of usage of the input system. Palm also came up with multi-stroke recognition techniques described in U.S. Pat. No. 6,493,464, suitable for writing Japanese and Chinese alphabet systems. However, these techniques are not suitable for improving efficiency of writing input. There are also other unistroke recognition techniques like U.S. Pat. No. 7,729,542 which relaxes the way user can draw the symbol. Again, such techniques are aimed at improving accuracy of recognition and none of the existing technologies have the capability to recognize successive characters spontaneously while the characters are being written with continuous stroke. Undeniably, capability to recognize multiple symbols written in a continuous stroke can significantly increase write input speed as it will avoid lifting the stylus. Further, spontaneous recognition of each symbol with immediate response displaying the recognized characters successively makes the input process very convenient. User can make a decision to stop and retry whenever false recognition is encountered at any character. This will not be possible if the recognition system waits for the user to write the complete word. There are prior arts which use regions on the write-pad to track the transition to new symbol. This means the user needs to pay attention to the write area diminishing the “eyes free” advantage of writing based input systems. This invention overcomes many of the prior art limitations to provide an easy, fast and accurate gesture based input system.

### SUMMARY

This invention comprises of a generic method to design a special class of short-hand gesture patterns called mayek and a versatile computational system to recognize the mayek patterns entered in sequence with a continuous stroke. As shown in FIG. 3, mayek patterns are composed of gesture segments with directions from two different direction sets. These gesture patterns can be entered with stroke drawn with various input methods 1) using stylus on touch surfaces 2) using fingers on touch surface 3) using any form of gesture in front of game console 4) input with joysticks or accelerometer for other devices. The current invention also outlines a methodology for mapping the mayek gesture patterns with traditional characters. The goal of this mapping approach is to make it easier for user to remember the corresponding short-hand gesture patterns mapped to the traditional characters. Further, an optional capability for translation of recognized characters to voice will enable users to write without looking at the device screen. This capability will enable users to enter the text in situations demanding eye focus like noting down input while in eye contact with the customer, walking and driving etc.

This input recognition system embodiment exploits the properties of mayek patterns for accurately recognizing the entered patterns spontaneously with immediate response. Spontaneous recognition mechanism does not require the user to signal for the end of input and consecutive input mayek patterns are recognized immediately while the stroke continues. This capability helps the user to avoid extra moves while entering patterns continuously and improves speed of text input. Also it avoids false detection by guiding the user to continue the stroke until the gesture pattern is correctly detected. This input recognition system uses a technique to detect the intention of the user and enables the user to enter text with relatively short strokes while tolerating significant error in the user input. It's naturally easier to learn and draw simple uniform patterns like mayek. Accuracy in detecting gesture patterns with short stroke is crucial for enabling easy and fast input. This system enables users to convenient to enter mayek patterns with thumb.

### DRAWINGS

In the drawings, closely related figures have the same number but different alphabetic suffixes.

FIG. 1 shows four direction sectors in the slanted direction set.

FIG. 2 shows four direction sectors in the upright direction set.

FIG. 3 shows examples of gesture strokes with alternating direction set (Mayek).

FIG. 4 shows mayek gesture patterns composed of maximum two segments (Mayek-2).

FIG. 5 shows a mapping of mayek-2 with ASCII characters in alphabetic mode.

FIG. 6 shows a mapping of mayek-2 with ASCII characters in miscellaneous mode.

FIG. 7 shows a gesture path diagram.

FIG. 8 shows a continuous mayek-2 gesture path representing input text “the”.

FIG. 9 shows a continuous mayek gesture recognition procedure.

FIG. 10 shows a mayek gesture recognition procedure at termination.

FIG. 11 shows a procedure for shifting the start point to the beginning of the next mayek pattern.

FIG. 12 shows a direction bitmap update procedure.

### DETAILED DESCRIPTION OF THE INVENTION

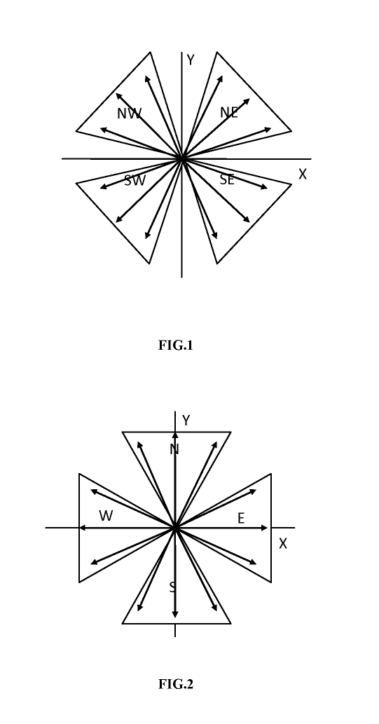

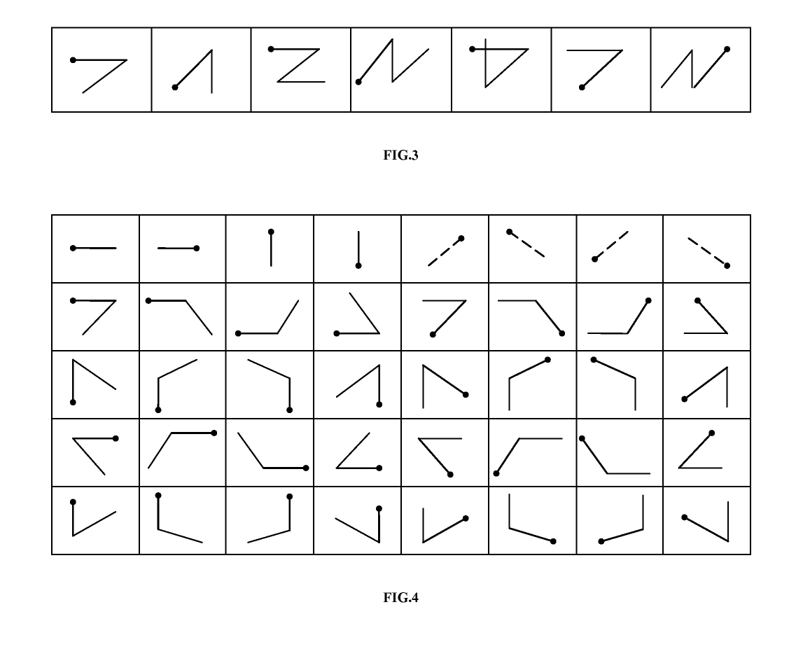

Mayek gesture patterns are formed by connected consecutive directional gesture segments. However, it's impossible for any user to input gesture strokes with perfectly accurate direction as indicated in the mayek gesture pattern. Therefore, a directional gesture is accepted if it falls in a range of directions forming a sector angle called direction sector on the X-Y coordinate plane. If the coordinate plane has to accommodate more direction sectors, the angles of the sectors have to be smaller and user can easily make mistakes while trying to input short gesture stroke along any direction sector. For reasonably short gesture strokes, the ease of accurately entering a gesture stroke in a specific direction can be achieved when there are about four or less direction sectors on the coordinate plane. We can see in FIG. 1 the 4 direction sectors in slanted direction set and in FIG. 2 the 4 direction sectors in straight direction set.

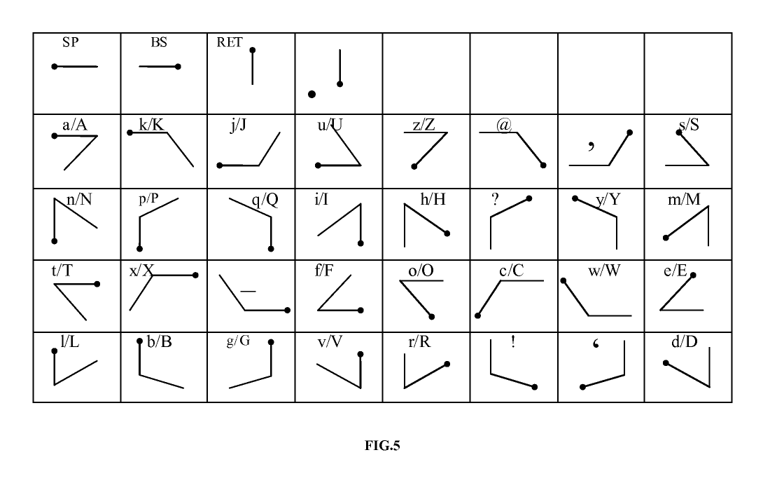

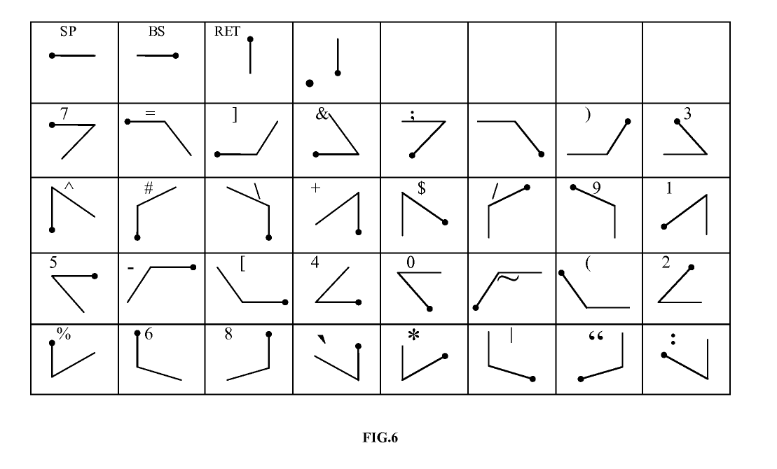

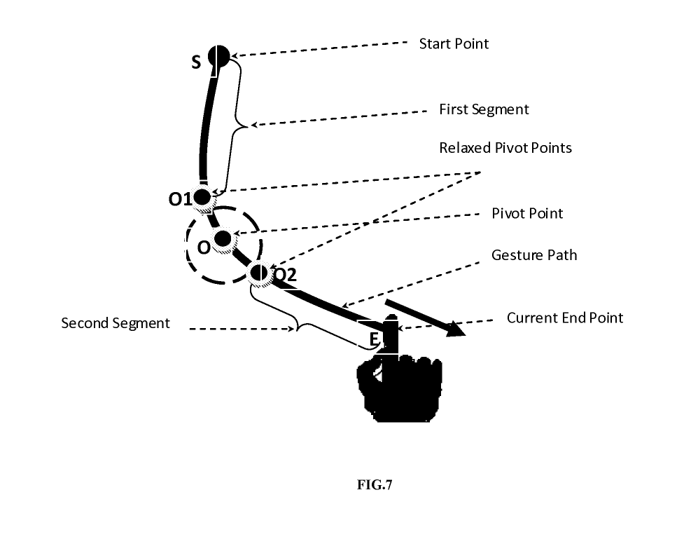

The number of possible unique mayek patterns is determined by the number of gesture segments composing the pattern. There are four possible different gesture segments with four direction sectors and also two consecutive gesture segments may not be along the same direction in order to enable spontaneous recognition. These constraints reduce the number of unique patterns that can be formed by combination of all the possible consecutive gesture segments. It means we need to increase the number of gesture segments to form the gesture pattern which worsens inconvenience in learning and entering the pattern. The number of possible unique gesture patterns can be maximized by using a pair of direction patterns shown in FIG. 1 and FIG. 2. The following points elaborate the properties of a mayek gesture pattern.
1. A mayek gesture pattern may be composed of one or more consecutive gesture segments which may be roughly straight lines along any of the direction sectors. Mayek patterns composed of more than one segments may have the adjacent segments aligned to alternate direction patterns as shown in FIG. 3. If a segment of the pattern is aligned to any of the straight direction sectors, the next segment may be aligned to any of the slanted direction sectors.
2. A set of mayek gesture patterns may be mapped to any desired set of characters and the input system can recognize and translate the mayek patterns to the corresponding text. FIG. 5 illustrates the mapping of the ASCII characters with the mayek-2 gesture patterns which is the subset of mayek patterns comprising of maximum two gesture segments. Such a mapping set may contain patterns with single segment either from the straight direction set or slanted direction set but not both. A choice is to use the pattern segments along straight direction sectors as indicated in FIG. 4.
3. In a mapping set of mayek there can be two types of gesture patterns 1) primary mayek patterns 2) residual mayek patterns.
   3.1. All the primary mayek patterns are composed of exactly the same number gesture segments and no primary pattern is sub-pattern of another pattern in the mapping set of mayek. Because of this property, the primary mayek patterns entered continuously in running writing style may be recognized spontaneously. For example, all the primary mayek-2 gesture patterns shown in FIG. 4 are composed of 2 gesture segments and they can be entered non-stop. The remaining patterns composed with 1 gesture segment are residual mayek-2 gesture patterns.
   3.2. The residual mayek patterns may be sub-patterns of the primary mayek patterns and they may be composed of lesser number of gesture segments. Unlike the primary mayek patterns, residual mayek patterns may not be entered in the non-stop running writing style and the residual patterns are recognized only after the gesture stop input event is encountered. The residual patterns supplement the mapping mayek set with patterns with smaller gesture path lengths which may be suitable for quick input. A residual pattern may be the last part of a running writing sequence of primary patterns.

A gesture segment may be a gesture curve which may be treated like a straight line segment. In order to find the direction of a segment, we compute the slope of the segment by either taking only the two end points or by taking average of some of the sub-segment slopes. Each direction is represented by a direction sector bounded by pair of rays emerging from the origin on the X-Y coordinate plane. Comparing the slope of the segment with the slopes of the bounding rays of the direction sectors, we can identify which direction sector the segment belongs. The directions are represented by bits and it can be copied to the direction bitmap for tracking directions. The bitmap is used as key to lookup the corresponding mapped character in the mayek pattern hash table. The following points describe the details of the direction sectors for the pair of alternate direction sets.
1. A gesture segment may be marked as belonging to slanted direction set and the direction bits for such segments can be identified by comparing the segment slope with the direction sectors comprising slanted direction set. FIG. 1 illustrates the direction sectors for slanted direction set.
   1.1. A segment marked with slanted direction set can have four direction sectors namely NE(north-east), NW(north-west), SE(south-east) and SW(south-west). These direction sectors face toward the four different quadrants on the X-Y coordinate plane. These directions are bounded by pair of angles measured from X and Y axes forming non-overlapping conic sectors on the X-Y coordinate plane.
   1.2. In order to find the slanted direction bits of a gesture segment, shift the origin of the X-Y coordinate plane to the start point of the gesture segment and identify the slanted direction sector in which the segment belongs. If the segment belongs to any of the direction sectors, the corresponding direction bits may be updated to the direction bitmap.
2. A gesture segment may be marked as belonging to straight direction set and the direction bits for such segments may be identified by comparing the segment slope with the direction sectors comprising straight direction set. FIG. 2 illustrates the direction sectors for straight direction set.
   2.1. Segment marked with straight direction set can have four direction sectors namely N(north), S(south), E(east) and W(west). The N direction sector faces towards the positive side of the Y axis and S direction sector faces towards the negative side of the Y axis. The E direction sector faces towards the negative side of X axis and W direction sector faces towards the positive side of X axis. These direction sectors are bounded by pair of angles measured from the X or Y axis forming non-overlapping conic sectors on the X-Y plane.
   2.2. In order to find the straight direction bits of a gesture segment, shift the origin of the X-Y coordinate plane to the start point of the segment and identify the straight direction sector in which the segment belongs. If the segment belongs to any of the direction sectors, the corresponding direction bits may be updated to the direction bitmap.

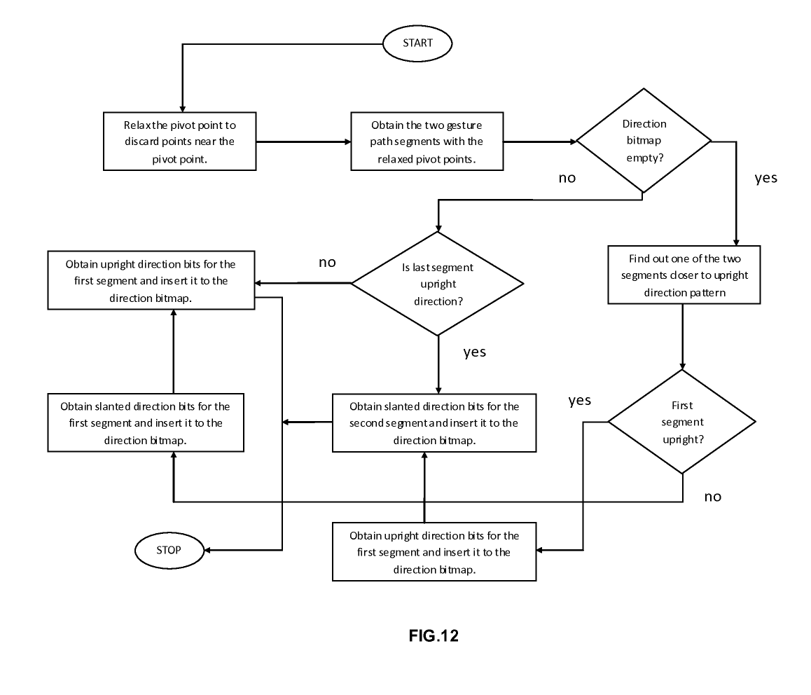

The adjacent segments of any mayek pattern may belong to two different direction sets—namely slanted direction set and straight direction set. Therefore, if we take any two adjacent segments in a mayek pattern say SO and OE, they may have different direction patterns. In other words, if SO is in slanted direction pattern, OE may be in straight direction pattern and the vice versa may be true. This technique may enhance gesture pattern input flexibility and detection accuracy significantly. The directions of the gesture segments represented by bits may be recorded in a direction bitmap data structure. The following steps describe the procedure to find out direction bits of the gesture segments. FIG. 12 illustrates the high level logic of this procedure.
1. Perform relaxation to remove some of the noisy points over the curve near the pivot point O. We use a tunable coefficient RELAX_COEFF and the desired value can vary depending on the resolution of the gesture position tracking device.
   1.1. RELAX_COEFF is some coefficient preferably in the range [0.2, 1]. If RELAX_COEFF is equal to 1, there is no relaxation.
   1.2. Find a point O₁ between S and O such that SO₁=˜SO*RELAX_COEFF.
   1.3. Find a point O₂ between O and E such that O2E=˜OE*RELAX_COEFF.
   1.4. The same relaxation technique can be extended for the points S and E to remove the noisy points at the extreme portions of the path.
2. If the direction bitmap is empty, it's the first time we are trying to detect directions of the segments and directions for both SO₁ and O₂E needs to be identified. Otherwise, go to step 3.
   2.1 Compare the slopes of SO₁ and O₂E to both horizontal and vertical axis and choose the segment whose slope is closest to either axis. If SO₁ is the chosen segment, it's marked as belonging to straight direction set. Otherwise, SO₁ is marked as belonging to slanted direction set.
   2.2. Insert the direction bitmap with direction bits for SO₁ if it matches with any of the direction sectors by following direction identification procedure described above. Otherwise, go to step 4.
3. If the SO₁ is marked as belonging to straight direction set, O₂E is marked as belonging to slanted direction set. Otherwise, O₂E is marked as belonging to straight direction set.
   3.1. Insert the direction bitmap with direction bits for O₂E if it matches with any of the direction sectors by following direction identification procedure described above. Otherwise, clear the direction bits for SO₁ from direction bitmap and go to step 4.
4. Record the current gesture path length of SE as LAST_PATH_LEN.

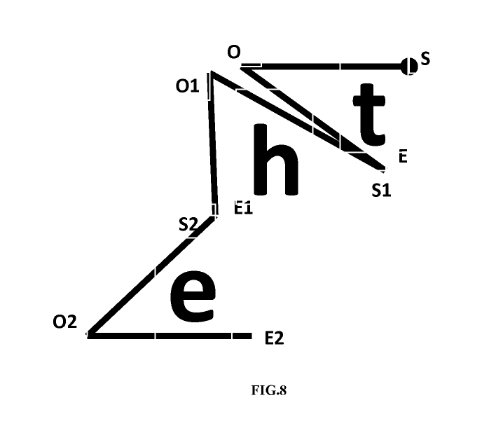

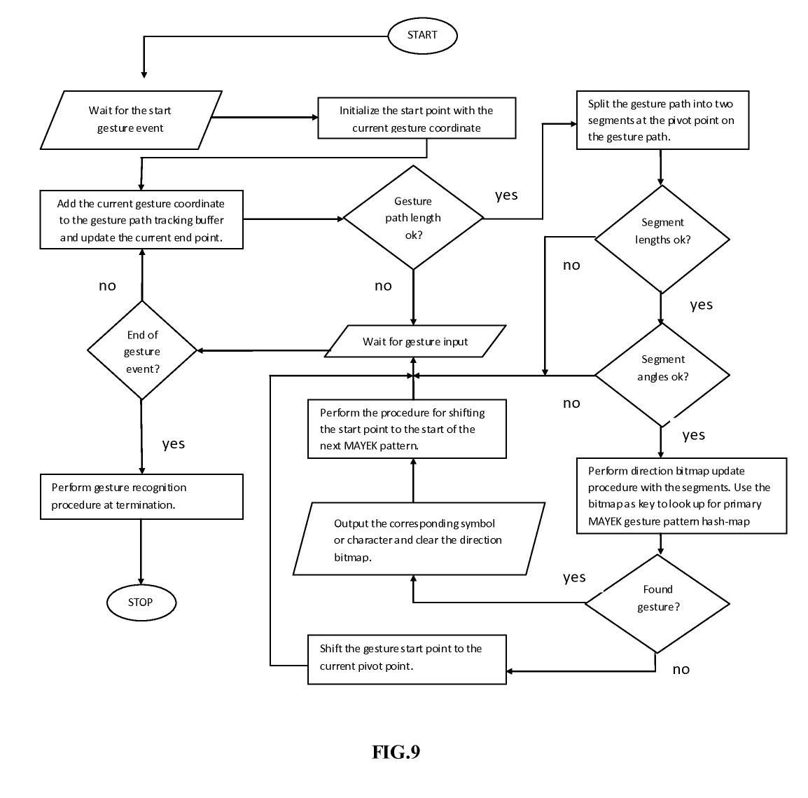

This system may spontaneously recognize successive mayek patterns inputted in non-stop running writing style as illustrated in FIG. 8. The recognition system uses a versatile technique of finding the pivot point on the gesture path and splitting the path into segments at the pivot point as seen in FIG. 7. Following steps describe in detail the procedure to spontaneously recognize mayek patterns entered continuously. High level logic of this procedure is illustrated in FIG. 9. Also refer to FIG. 7 for visual details of the gesture path. This procedure makes use of many tunable threshold parameters to adjust the sensitivity of recognition.
1. On gesture input start event, initialize the input buffer with start point S and end point E pointing to the initial coordinate point placed at the beginning of the buffer.
2. Wait for gesture input and for every gesture input point, the input buffer is updated with the new entry and the end point E is moved to the current input point.
3. Check if the total path length of the gesture from the start point S to the end point E is more than a threshold DETECT_PATH_LEN_TH. If (SE<DETECT_PATH_LEN_TH), then go to step 2.
4. Find pivot point O on the gesture path SE is such that sum of the lengths of the straight line segments SO and OE is maximized. This point represents the maximum moment point where the gesture direction changed maximum with respect to the start and the end points.
   4.1. Find out O such that for any other point O₁ on the path SE, |SO|+|OE|>=|SO₁|+|O₁E|
5. Check for segment length constraints.
   5.1. Check if the length of the segment SO is more than the minimum first segment threshold DETECT_SEG1_LEN_TH. If (SO<DETECT_SEG1_LEN_TH), then go to step 2.
   5.2. Check if the difference between segment lengths of SO and OE within the acceptable range by calculating a fraction DETECT_DIFF_COEFF of the total SE length. If (|SO−OE|<SE*DETECT_DIFF_COEFF), then go to step 2.
6. Check for segment angle constraints.
   6.1. Check if the angle formed between SO and OE line segments is more than a maximum angle threshold DETECT_ANGLE_MAX_TH. If (angle(SOE)>DETECT_ANGLE_MAX_TH), then go to step 2.
   6.2. Check if the angle formed between SO and OE line segments is less than a minimum angle threshold DETECT_ANGLE_MIN_TH. If (angle(SOE)<DETECT_ANGLE_MIN_TH), then go to step 2.
7. Perform the direction bitmap update procedure described above. The resulting bitmap may be used as key to look up from the primary hash table.
   7.1. A primary hash table may be populated with the primary mayek patterns encoded as direction bitmap of the pattern segments as key and the corresponding mapped character as value.
   7.2. If hash lookup succeeded, then the character found may be output to the relevant display channel and also the direction bitmap may be cleared. The character output may be translated to voice optionally. Further, the procedure to shift the start point may be performed to recognize subsequent mayek patterns.
   7.3. If hash lookup failed, the gesture start point may be shifted to the currently found pivot point. The successive shifting of the start point may enable recognizing patterns comprising any number of segments. Then, go to step 2 to wait for further input.
8. On gesture input stop event, perform the gesture recognition procedure on termination described in the following.

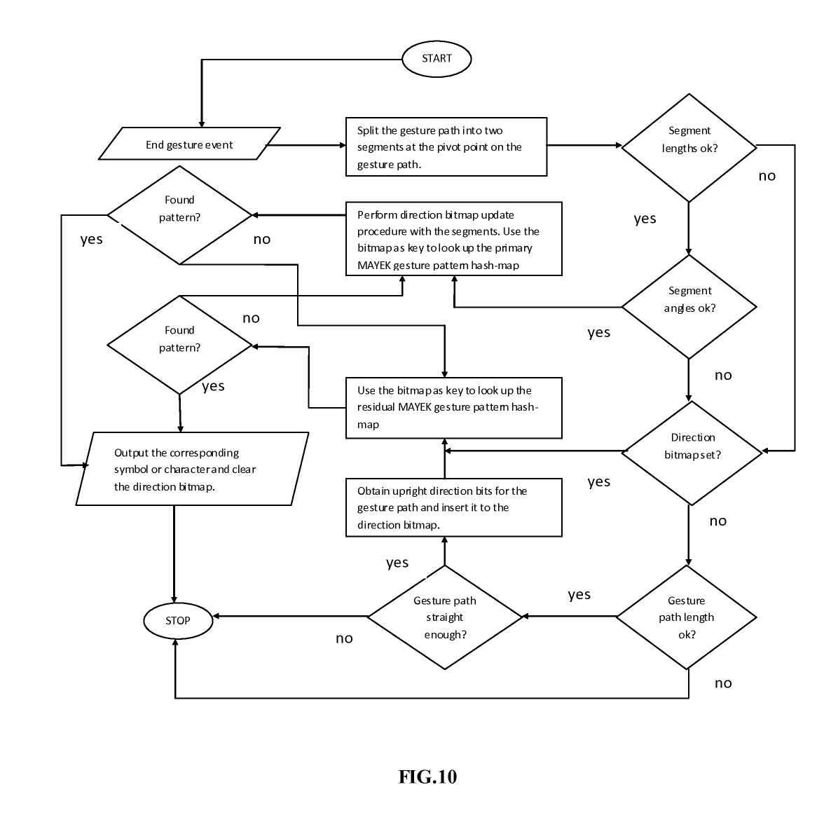

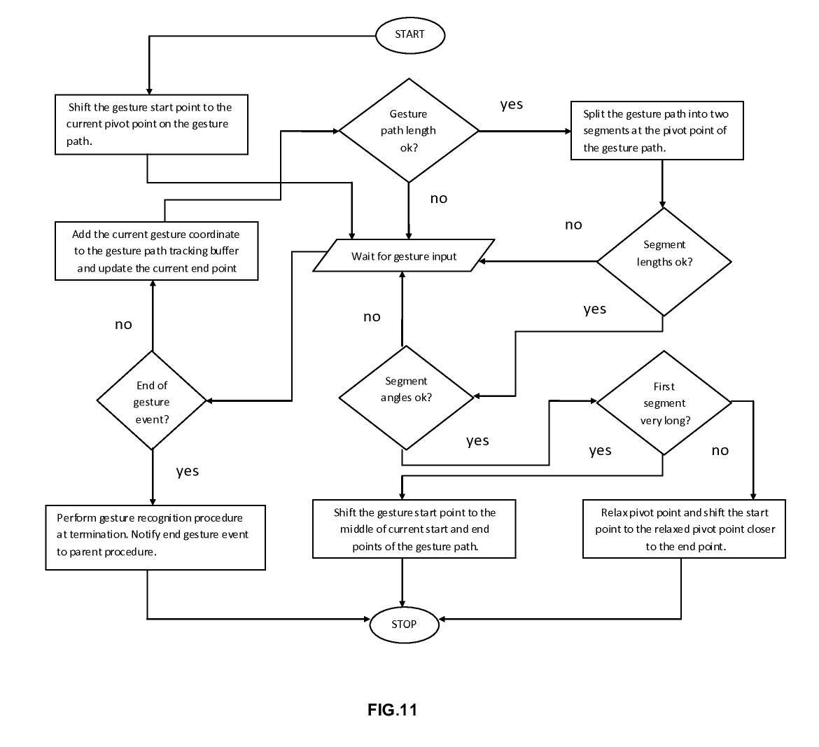

FIG. 10 illustrates the high level procedure for recognition of mayek pattern after user signals gesture stop event. This procedure at termination of the gesture input may have more relaxed constraints than the procedure to spontaneously recognize the patterns entered continuously. This means the tunable parameters of this procedure may be set to less restrictive threshold values. This is because for continuous input, user may be more restricted to follow the patterns accurately to avoid noisy input for the successive patterns. Further, residual mayek patterns may be recognized after stop of gesture event. The following procedure described the steps to recognize a gesture pattern after termination of the gesture.
1. Check if the total path length of the gesture from the start point S to the end point E is more than a minimum threshold at termination TERM_DETECT_PATH_LEN_TH. If (SE<TERM_DETECT_PATH_LEN_TH), stop the procedure. Otherwise go to step 6.
2. Find pivot point O on the gesture path SE and split the gesture path into two gesture segments.
3. Check for segment length constraints.
   3.1. Check if the length of the segment SO is more than a minimum first segment threshold at termination TERM_DETECT_SEG1_LEN_TH. If (SO<TERM_DETECT_SEG1_LEN_TH), go to step 6.
   3.2. Check if the difference between segment lengths of SO and OE within the acceptable range by calculating a fraction TERM_DETECT_DIFF_COEFF of the total SE length. If (|SO−OE|<SE*TERM_DETECT_DIFF_COEFF), go to step 6.
4. Check for segment angle constraints.
   4.1. Check if the angle formed between SO and OE line segments is more than a maximum angle threshold at termination TERM_DETECT_ANGLE_MAX_TH. If (angle(SOE)>TERM_DETECT_ANGLE_MAX_TH), go to step 6.
   4.2. Check if the angle formed between SO and OE line segments is less than a minimum angle threshold at termination TERM_DETECT_ANGLE_MIN_TH. If (angle(SOE)<TERM_DETECT_ANGLE_MIN_TH), go to step 6.
5. Perform the direction bitmap update procedure described earlier. The resulting bitmap may be used as key to look up from the primary hash table.
   5.1. If hash lookup succeeded, then the character found may be output to the relevant input stream and procedure is stopped. The character output may also be translated to voice optionally.
   5.2. If the hash table lookup failed and no primary patterns are earlier recognized as part of the current gesture input, then go to step 10. The procedure is stopped here if primary patterns are recognized earlier.
6. If primary patterns are earlier recognized as part of the current gesture input, the procedure is stopped here. In order to improve accuracy, the residual patterns may be recognized when no primary patterns are recognized the gesture input.
7. Check if the gesture path length SE is more than a minimum residual pattern threshold RESIDUAL_PATH_LEN_TH. If (SE<RESIDUAL_PATH_LEN_TH), procedure is stopped.
8. Check if the curve SE is straight enough to represent a single line segment.
   8.1. Check if the angle formed between SO and OE line segments is less than a maximum angle threshold for residual patterns RESIDUAL_ANGLE_TH. If (angle(SOE)>RESIDUAL_ANGLE_TH), procedure is stopped here.
9. Update direction bitmap with the direction bits for SE segment.
   9.1. The possible directions for SE are N, S, E and W which are represented by non-overlapping direction sectors in the X-Y plane as shown in FIG. 2.
   9.2. Shift the origin of the X-Y plane to the point S and match which conic sector SE belongs. The direction corresponding to the conic sector may be updated to the direction bitmap. If no match is found nothing is updated to the direction bitmap.
10. Use the bitmap as key to look up from the residual hash table.
   10.1. A residual hash table may be populated with the residual mayek patterns. The encoded direction bits of the pattern segments may be the keys and corresponding character the value in the hash map.
   10.2. If hash table lookup succeeded, then the character found may be output to the relevant input stream and also character output may be translated to voice optionally.

Recognition of continuous running writing style gesture input is achieved by spontaneous recognition of successive mayek gesture patterns entered one after another. After recognizing a pattern, the system may shift the gesture path start point to the start point of the next pattern and perform the recognition procedure discussed in the previous section. The following steps describe the steps of detecting the start point of the next gesture pattern. In order to tolerate the user input inaccuracy, a technique of delaying the detection until the moment when the gesture path direction change is encountered. The overview of this procedure is illustrated in the FIG. 13.
1. Shift the start point S of the gesture path to the last pivot point O.
2. Wait for further gesture inputs. If end of gesture input event is registered, perform the above procedure for mayek pattern recognition at termination and the recognition procedure stops. The parent procedures calling this procedure may be notified to stop.
3. Check if the gesture path length SE is more than a minimum threshold NEXT_PATH_LEN_TH required for detecting next gesture pattern start point. The tunable parameter NEXT_PATH_LEN_TH can be adjusted for better efficiency of the system. If (SE<NEXT_PATH _LEN_TH), then go to step 2.
4. Find out the pivot point O as described in the previous section and split the gesture path into two segments.
5. Check if the length of the first segment SO is more than a minimum threshold NEXT_SEG1_LEN_TH required for detecting next gesture pattern start point. If (SO<NEXT_SEG1_LEN_TH), then go to step 2.
5. Check if the difference between segment lengths of SO and OE is within the acceptable range by calculating a fraction NEXT_DIFF_COEFF of the total SE length. If (SO−OE<SE*NEXT_DIFF_COEFF), then go to step 2.
6. Check if the angle formed between SO and OE line segments is more than a minimum angle threshold NEXT_ANGLE_TH required for initializing next symbol input. If (angle(SOE)<NEXT_ANGLE_TH), then go to step 2.
7. Compare the length of the segment SO with the gesture path length of the two previously known consecutive segments LAST_PATH_LEN. Instead of directly comparing with LAST_PATH_LEN, a larger fraction of the path length is computed by multiplying with a tunable coefficient LAST_PATH_COEFF.
   7.1. If ((LAST PATH_LEN*LAST_PATH_COEFF)<SO), then shift the start point S to the middle point between S and O.
   7.2. Otherwise, find the relaxed pivot point O₂ on the gesture path which is near the pivot point O and slightly towards the end point. The relaxed pivot point avoids the noisy points forming a significantly curved path near the pivot point. Shift the start point S to the relaxed pivot point O₂.

### CONCLUSION

Short-hand gesture based input systems can have mass appeal if 1) it provides convenience of entering text 2) it enables users reasonably good speed of entering text 3) users can start using from day one 4) it's easy to remember the sort-hands after few usages. The features 1) and 2) will make the input systems addictive to use after it has been adopted. In the previous paragraphs we have discussed how short mayek patterns can be recognized with high degree of user inaccuracy tolerance. In order to keep the gesture patterns shorter we need to limit the number of segments composing a pattern. In fact, the same pattern may be mapped to different characters in different modes of operations as illustrated in FIG. 5 and FIG. 6. Users may switch between different modes by pressing special buttons or by entering special mayek gesture patterns reserved for this purpose.

On the other hand, features 3) and 4) are crucial for new users to adopt such input system. The mapping of the mayek patterns with the characters or controls may be shown on the display screen and special buttons may be present at the gesture input area. If the gesture input area is also display area, then a control may be provided to operate the gesture input area in full screen or normal mode and also a control may be provided to hide or show the mappings. The mapping may be done by first picking the mayek patterns whose edges can be drawn either superimposing or parallel to the structure of the characters.

So far, no existing technologies or prior art addresses decisively the four key features discussed above. The current invention aims at making gesture based input system practical and widely adopted by mainstream users. The descriptions of the current invention focus on gesture patterns in two dimensional planes but the same technique can be extended to three dimensional spaces.

Although the description above contains much specificity, these should not be construed as limiting the scope of the embodiments but as merely providing illustrations of some of several embodiments. For example, the gesture recognition procedure can be applied to any other directional gesture patterns not limited to mayek gesture patterns.

Thus the scope of the embodiments should be determined by the appended claims and their legal equivalents, rather than by the examples given.

I claim:

1. A system for recognizing gesture input patterns comprising:
(a) a set of directions each corresponding to predefined sector on the coordinate plane,
(b) a set of gesture patterns each composed by a sequence of directions from said set of directions,
(c) a user interface pointer to input motion gestures following said sequence of directions corresponding to any of said gesture patterns, a mechanism for user to signal start and end of a gesture session, multiple gesture patterns may be inputted in a single gesture session,
(d) a sensor tracking the motion of said pointer by recording the spatial coordinates of said pointer in a list sequentially in time order,
(e) a recognition unit responds to said pointer input, processes said list of coordinates, recognized a series of said gesture patterns successively by matching the directions followed by said pointer,
(f) a display to output the desired outcome after recognizing any of said gesture patterns,

2. The system of claim 1 wherein said user interface pointer may be a stylus, said user interface pointer may be finger tip, said gesture tracking sensor may be a touch sensing surface.

3. The system of claim 1 wherein said user interface pointer may be a light source object and said gesture tracking sensors may be cameras tracking position of said light source object.

4. The system of claim 1 wherein both said interface pointer and said gesture tracking sensor may be accelerometer.

5. A computer readable medium, storing executable instructions for recognizing directional gesture patterns entered to the computer with a gesture input pointer via an input device interface, the executable instructions comprising:
(a) providing a set of directions on the coordinate plane encoded as bits in the computer memory, each of said directions corresponds to a predefined sector on the coordinate plane,
(b) providing a set of gesture patterns in the computer memory, each gesture pattern is a sequence of said directions stored as an ordered list of said encoded direction bits,
(c) providing gesture tracking buffer in the computer memory for tracking the positions of said gesture input pointer. Said gesture input pointer positions are inserted to said tracking buffer sequentially in time order during a gesture session, said gesture session starts when signal received for the begin gesture of said gesture input pointer, said gesture session continues when receiving the move signal of said gesture input pointer and said gesture session ends when signal received for the end gesture of said gesture input pointer,
(d) dividing the gesture path represented by said gesture tracking buffer into a sequence of gesture segments, transforming said gesture segments to an ordered list of line segments,
(e) detecting the direction of said line segment, computing the slope angle for each of said line segments, identifying said predefined sector which encloses said slope angle, choosing the direction in said directions set corresponding to said identified sector, inserting said chosen directions sequentially in time order into a direction tracking list provided in the computer memory,
(f) recognizing the gesture patterns in said direction tracking list sequentially by matching with the directions from said set of gesture patterns, send said recognized gesture patterns to the output processing unit,

6. The process of claim 5 wherein said dividing of the gesture path is done sequentially at the pivot points on said gesture path, the process comprising:
(a) initializing a start point with the first point on said gesture tracking buffer,
(b) finding the initial gesture segment starting from said start point such that said gesture segment is longer than a configured minimum length threshold,
(c) finding said pivot point on said initial gesture segment such that sum of the lengths of line segments formed by joining said pivot point to the start and end points of said initial gesture segment is maximized, said pivot point divides said gesture segment to two sub-segments,
(d) checking further for pivot point criteria, said sub-segments are longer than their respective configured minimum length thresholds, the ratio of lengths of said second sub-segment, said first sub-segment is greater than a configured minimum value threshold, transforming said sub-segments to two line segments by joining the respective start and end points of said sub-segments, the angle between said line segments is more than a configured angle threshold,
(e) repeatedly trying to find the pivot point, if said pivot point criteria are not satisfied, increase said initial gesture segment length by including more points in said gesture tracking buffer, repeat from step (c),
(f) dividing the gesture path successively, if said pivot point criteria are satisfied, re-initialize start point to said pivot point and repeat from step (b) to find the subsequent pivot points,

7. The process of claim 5 wherein said transformation of the gesture segments to said ordered list of line segments comprising:
(a) discarding last gesture segment if the length of said last gesture segment is less than a configured length threshold,
(b) forming line segments for each of the remaining gesture segments by joining the corresponding begin and end points of said gesture segments, inserting sequentially said line segments to said ordered list of line segments in time order,

8. The process of claim 5 wherein every gesture segment in said sequence of gesture segments is further divided in the middle if there exists a gesture segment preceding said gesture segment and the ratio of said gesture segment to said preceding gesture segment is more than a configured value threshold.

9. The process of claim 5 wherein said gesture patterns are composed with a sequence of directional gesture segments comprising:
(a) choosing a set of directions each corresponding to predefined sector on the coordinate plane, divide said directions set into two subsets of directions,
(b) allocating angle bounds for said sectors corresponding to each of said directions such that said sectors corresponding to any two adjacent directions in the same said subset do not overlap,
(c) compose gesture patterns by joining in sequence the directions picked alternately from the two said direction subsets, said gesture patterns are called mayek,

10. The process of claim 9 wherein said direction detection process comprising:
(a) dividing said set of directions into two subsets, said direction sectors in the same subset do not overlap but said direction sectors in different subsets may overlap, designating one of the direction subsets as primary direction subset and the other as secondary direction subset,
(b) assigning directions alternately from said subsets, if said ordered list of line segments contains more than one line segments, mark the line segment out of the first two line segments whose slope is closest to the bisector of any of the direction sectors in said primary subset, the alternate line segments in said sequence of line segments are assigned with different subsets from said direction subsets such that said marked line segment is assigned with said primary direction subset,
(c) assigning direction subset for the ending gesture segment, if just one gesture segment found at the end of the gesture session, said gesture segment is assigned with said primary direction subset,
(d) computing the slope angle for each line segment of said line segments, choosing the direction from said assigned direction subset for said line segment by finding out said predefined direction sector corresponding to the direction which encloses said computed slope angle, inserting said chosen directions sequentially in time order into a direction tracking list provided in the computer memory,

11. The process of claim 5 wherein said recognition of the gesture pattern comprising:
(a) dividing said gesture patterns set into primary patterns subset and residual patterns subset, the direction sequences of the gesture patterns in said primary pattern subset is not a prefix sequence of a direction sequence for another gesture pattern in said gesture patterns set, the direction sequences of the gesture patterns in said residual patterns subset may be a prefix sequence of a direction sequence for another gesture pattern in said gesture patterns set,
(b) the gesture patterns in said primary patterns subset may be recognized during said gesture session or after said gesture session ends, scan forward sequentially said direction tracking list and match with the direction sequences of gesture patterns in said primary patterns subset, finding a match results in recognition of the matched gesture pattern and discard the matched direction bits from said direction tracking list, repeat this step (b) to recognize the subsequent gesture patterns in said primary patterns subset until no more patterns can be recognized,
(c) said residual gesture patterns may be recognized after the gesture session ends and unmatched direction bits are left in said direction tracking list after the previous step (b), scan forward sequentially said unmatched direction bits and try to match with a gesture pattern in said residual patterns subset, finding a match results in recognizing the gesture pattern,

12. The process of claim 5 wherein said output processing unit maps the gesture patterns to input keys and control functions, sends said input keys to the input stream, performs pre-defined actions for the input control functions.

13. A method of recognizing directional gesture patterns entered with a gesture input pointer via an input device interface, the executable instructions comprising:
(a) a set of directions on the coordinate plane, each of said directions corresponds to a predefined sector on the coordinate plane,
(b) a set of gesture patterns, each gesture pattern is a sequence of said directions stored as an ordered list of said directions,
(c) a gesture tracking buffer for tracking the positions of said gesture input pointer. Said gesture input pointer positions are inserted to said tracking buffer sequentially in time order during a gesture session, said gesture session starts when event received for the begin gesture of said gesture input pointer, said gesture session continues when receiving the move event of said gesture input pointer and said gesture session ends when event received for the end gesture of said gesture input pointer,
(d) dividing the gesture path represented by said gesture tracking buffer into a sequence of gesture segments, transforming said gesture segments to an ordered list of line segments,
(e) detecting the direction of said line segment, computing the slope angle for each of said line segments, identifying said predefined sector which encloses said slope angle, choosing the direction in said directions set corresponding to said identified sector, inserting said chosen directions sequentially in time order into a direction tracking list,
(f) recognizing the gesture patterns in said direction tracking list sequentially by matching with the directions from said set of gesture patterns, send said recognized gesture patterns to the output processing unit,

14. The method of claim 13 wherein said dividing of the gesture path is done sequentially at the pivot points on said gesture path, the process comprising:
(a) initializing a start point with the first point on said gesture tracking buffer,
(b) finding the initial gesture segment starting from said start point such that said gesture segment is longer than a configured minimum length threshold,
(c) finding said pivot point on said initial gesture segment such that sum of the lengths of line segments formed by joining said pivot point to the start and end points of said initial gesture segment is maximized, said pivot point divides said gesture segment to two sub-segments,
(d) checking further for pivot point criteria, said sub-segments are longer than their respective configured minimum length thresholds, the ratio of lengths of said second sub-segment, said first sub-segment is greater than a configured minimum value threshold, transforming said sub-segments to two line segments by joining the respective start and end points of said sub-segments, the angle between said line segments is more than a configured angle threshold,
(e) repeatedly trying to find the pivot point, if said pivot point criteria are not satisfied, increase said initial gesture segment length by including more points in said gesture tracking buffer, repeat from step (c),
(f) successively dividing of the gesture path, if said pivot point criteria are satisfied, re-initialize start point to said pivot point and repeat from step (b) to find the subsequent pivot points,

15. The method of claim 13 wherein said transformation of the gesture segments to said ordered list of line segments comprising:
(a) discarding last gesture segment if the length of said last gesture segment is less than a configured length threshold,
(b) forming line segments for each of the remaining gesture segments by joining the corresponding begin and end points of said gesture segments, inserting sequentially said line segments to said ordered list of line segments in time order,

16. The method of claim 13 wherein every gesture segment in said sequence of gesture segments is further divided in the middle if there exists a gesture segment preceding said gesture segment and the ratio of said gesture segment to said preceding gesture segment is more than a configured value threshold.

17. The method of claim 13 wherein said gesture patterns are composed with a sequence of directional gesture segments comprising:
(a) choosing a set of directions each corresponding to predefined sector on the coordinate plane, divide said directions set into two subsets of directions,
(b) allocating angle bounds for said sectors corresponding to each of said directions such that said sectors corresponding to any two adjacent directions in the same said subset do not overlap,
(c) compose gesture patterns by joining in sequence the directions picked alternately from the two said direction subsets, said gesture patterns are called mayek,

18. The method of claim 17 wherein said recognition of the gesture pattern comprising:
(a) dividing said set of directions into two subsets, said direction sectors in the same subset do not overlap but said direction sectors in different subsets may overlap, designating one of the direction subsets as primary direction subset and the other as secondary direction subset,
(b) assigning directions alternately from said subsets, if said ordered list of line segments contains more than one line segments, mark the line segment out of the first two line segments whose slope is closest to the bisector of any of the direction sectors in said primary subset, the alternate line segments in said sequence of line segments are assigned with different subsets from said direction subsets such that said marked line segment is assigned with said primary direction subset,
(c) assigning direction subset for the ending gesture segment, if just one gesture segment found at the end of the gesture session, said gesture segment is assigned with said primary direction subset,
(d) computing the slope angle for each line segment of said line segments, choosing the direction from said assigned direction subset for said line segment by finding out said predefined direction sector corresponding to the direction which encloses said computed slope angle, inserting said chosen directions sequentially in time order into a direction tracking list,

19. The process of claim 13 wherein said recognition of the gesture pattern comprising:
(a) dividing said gesture patterns set into primary patterns subset and residual patterns subset, the direction sequences of the gesture patterns in said primary pattern subset is not a prefix sequence of a direction sequence for another gesture pattern in said gesture patterns set, the direction sequences of the gesture patterns in said residual patterns subset may be a prefix sequence of a direction sequence for another gesture pattern in said gesture patterns set,
(b) the gesture patterns in said primary patterns subset may be recognized during said gesture session or after said gesture session ends, scan forward sequentially said direction tracking list and match with the direction sequences of gesture patterns in said primary patterns subset, finding a match results in recognition of the matched gesture pattern and discard the matched directions from said direction tracking list, repeat this step (b) to recognize the subsequent gesture patterns in said primary patterns subset until no more patterns can be recognized,
(c) said residual gesture patterns may be recognized after the gesture session ends and unmatched directions are left in said direction tracking list after the previous step (b), scan forward sequentially said unmatched directions and try to match with a gesture pattern in said residual patterns subset, finding a match results in recognizing the gesture pattern,

20. The method of claim 13 wherein said output processing unit maps the gesture patterns to input keys and control functions, sends said input keys to the input stream, performs pre-defined actions for the input control functions.
